(19) United States
(12) Patent Application Publication
(10) Pub. No.: US 2024/0142320 A1
(43) Pub. Date: May 2, 2024

(54) LOAD DETECTION SYSTEM

(71) Applicant: Panasonic Intellectual Property Management Co., Ltd., Osaka (JP)

(72) Inventors: Hironobu UKITSU, Osaka (JP); Yuta MORIURA, Osaka (JP); Susumu URAGAMI, Kumamoto (JP); Takashi MATSUMOTO, Osaka (JP)

(21) Appl. No.: 18/410,843

(22) Filed: Jan. 11, 2024

Related U.S. Application Data
(63) Continuation of application No. PCT/JP2022/014161, filed on Mar. 24, 2022.

(30) Foreign Application Priority Data
Jul. 20, 2021 (JP) 2021-119923

(51) Int. Cl. G01L 1/14

(52) U.S. Cl. CPC G01L 1/144; G01L 1/146

(57) ABSTRACT

A load detection system includes: a first load sensor including a first element part in which capacitance changes in accordance with a load; a first detection circuit configured to perform charging and discharging of the first element part and acquire a voltage according to the capacitance at a detection timing in a charge period; a second load sensor including a second element part in which capacitance changes in accordance with a load; a second detection circuit configured to perform charging and discharging of the second element part and acquire a voltage according to the capacitance at a detection timing in a charge period; and a synchronization generation part configured to synchronize the charging of the first element part and the charging of the second element part.

### CROSS REFERENCE TO RELATED APPLICATION

This application is a continuation of International Application No. PCT/JP2022/014161 filed on Mar. 24, 2022, entitled “LOAD DETECTION SYSTEM”, which claims priority under 35 U.S.C. Section 119 of Japanese Patent Application No. 2021-119923 filed on Jul. 20, 2021, entitled “LOAD DETECTION SYSTEM”. The disclosures of the above applications are incorporated herein by reference.

### BACKGROUND OF THE INVENTION

### Field of the Invention

The present invention relates to a load detection system including a plurality of load sensors.

### Description of Related Art

Load sensors are widely used in the fields of industrial apparatuses, robots, vehicles, and the like. In recent years, in accordance with advancement of control technologies by computers and improvement of design, development of electronic apparatuses that use a variety of free-form surfaces such as those in human-form robots and interior equipment of automobiles is in progress. In association therewith, it is required to mount a high performance load sensor to each free-form surface.

Japanese Laid-Open Patent Publication No. 2021-081341 describes a load sensor that detects a load applied from outside, based on change in capacitance. In this load sensor, a plurality of element parts that can respectively and individually detect a load are disposed so as to be adjacent to each other in a plane direction. During load detection, an element part serving as a detection target is sequentially switched. Capacitance which changes in accordance with a load is acquired as a voltage that occurs in each element part.

When a plurality of the load sensors as above are further disposed so as to be arranged, the load can be detected in a wider range. In this case, a detection circuit that detects change in voltage of the element part according to the load is individually provided for each load sensor. Further, each detection circuit is connected to a higher-order circuit that controls the system. For example, a power supply and a ground that are used in common are applied to each detection circuit and the higher-order circuit. Accordingly, these detection circuits and the higher-order circuit are integrated in a single circuit system.

However, when a plurality of detection circuits are integrated in a single circuit system like this, noise having occurred in one detection circuit may propagate to another detection circuit via a power supply line or the like. Accordingly, accuracy of the voltage acquired by the other detection circuit may decrease, and as a result, detection accuracy of the entire system may decrease.

### SUMMARY OF THE INVENTION

A load detection system according to a main aspect of the present invention includes: a first load sensor including a first element part in which capacitance changes in accordance with a load; a first detection circuit configured to perform charging and discharging of the first element part and acquire a voltage according to the capacitance at a detection timing in a charge period; a second load sensor including a second element part in which capacitance changes in accordance with a load; a second detection circuit configured to perform charging and discharging of the second element part and acquire a voltage according to the capacitance at a detection timing in a charge period; and a synchronization generation part configured to synchronize the charging of the first element part and the charging of the second element part.

In the first detection circuit and the second detection circuit, large noise tends to occur during discharge for each element part. Therefore, while discharging is performed in one detection circuit, if a voltage is acquired in the other detection circuit, the acquired voltage is influenced by the noise from the one detection circuit.

In contrast to this, in the load detection system according to the above aspect, charging of the first element part and charging of the second element part are synchronized with each other. Thus, overlapping of the discharge period for the one element part with the detection timing for the other element part is avoided. Therefore, the voltage acquired by the other detection circuit can be suppressed from being influenced by noise from the one detection circuit. Accordingly, the load applied to each element part in the first load sensor and the second load sensor can be accurately measured.

The effects and the significance of the present invention will be further clarified by the description of the embodiments below. However, the embodiments below are merely examples for implementing the present invention. The present invention is not limited to the description of the embodiments below in any way.

### BRIEF DESCRIPTION OF THE DRAWINGS

FIG. 1A is a perspective view schematically showing a sheet-shaped member and electrically-conductive elastic bodies set on an opposing face of the sheet-shaped member, according to Embodiment 1;

FIG. 1B is a perspective view schematically showing a state where conductor wires are set on the structure in FIG. 1A, according to Embodiment 1;

FIG. 2A is a perspective view schematically showing a state where threads are set on the structure in FIG. 1B, according to Embodiment 1;

FIG. 2B is a perspective view schematically showing a state where a sheet-shaped member is set on the structure in FIG. 2A, according to Embodiment 1;

FIG. 3A and FIG. 3B each schematically show a cross section of the electrically-conductive elastic body and the conductor wire, according to Embodiment 1;

FIG. 4 is a plan view schematically showing a configuration of the inside of a load sensor, according to Embodiment 1;

FIG. 5 is a circuit diagram showing a configuration of a detection circuit, according to Embodiment 1;

FIG. 6 is a circuit diagram schematically showing states of the load sensor and the detection circuit during charge, according to Embodiment 1;

FIG. 7 is a circuit diagram schematically showing states of the load sensor and the detection circuit during discharge, according to Embodiment 1;

FIG. 8 is a block diagram showing a configuration of a load detection system, according to Embodiment 1;

FIG. 9 schematically shows configurations of a plurality of the detection circuits and a system-side microcomputer, and transmission/reception of signals, according to Embodiment 1;

FIG. 10 is a time chart showing states of a synchronization signal, a measurement signal, a charge/discharge signal, a count-up signal, and a potential signal outputted from a signal processing circuit to a microcomputer in each detection circuit, according to Embodiment 1;

FIG. 11A is a graph schematically showing the potential signal acquired by the detection circuit, according to Comparative Example;

FIG. 11B is a graph schematically showing the potential signal acquired by the detection circuit, according to Embodiment 1;

FIG. 12 schematically shows configurations of a plurality of the detection circuits and the system-side microcomputer, and transmission/reception of signals, according to Embodiment 2;

FIG. 13 schematically shows configurations of a plurality of the detection circuits and the system-side microcomputer, and transmission/reception of signals, according to Embodiment 3;

FIG. 14 schematically shows configurations of a plurality of the detection circuits and the system-side microcomputer, and transmission/reception of signals, according to Embodiment 4; and

FIG. 15 is a time chart showing states of the synchronization signal, the measurement signal, the charge/discharge signal, and the count-up signal.

It is noted that the drawings are solely for description and do not limit the scope of the present invention in any way, according to a modification.

### DETAILED DESCRIPTION

The load detection system according to the present invention is applicable to a management system or the like that performs processing in accordance with an applied load. In such a management system, for example, a plurality of load sensors can be used in order to detect a load in a wider range.

Examples of the management system include a stock management system, a driver monitoring system, a coaching management system, a security management system, and a caregiving/nursing management system.

In the stock management system, for example, by a load sensor provided to a stock shelf, the load of a placed stock is detected, and the kinds of commodities and the number of commodities present on the stock shelf are detected. Accordingly, in a store, a factory, a warehouse, and the like, the stock can be efficiently managed, and manpower saving can be realized. In addition, by a load sensor provided in a refrigerator, the load of food in the refrigerator is detected, and the kinds of the food and the quantity and amount of the food in the refrigerator are detected. Accordingly, a menu that uses food in a refrigerator can be automatically proposed.

In the driver monitoring system, by a load sensor provided to a steering device, the distribution of a load (e.g., gripping force, grip position, tread force) applied to the steering device by a driver is monitored, for example. In addition, by a load sensor provided to a vehicle-mounted seat, the distribution of a load (e.g., the position of the center of gravity) applied to the vehicle-mounted seat by the driver in a seated state is monitored. Accordingly, the driving state (sleepiness, mental state, and the like) of the driver can be fed back.

In the coaching management system, for example, by a load sensor provided to the bottom of a shoe, the load distribution at a sole is monitored. Accordingly, correction or guidance to an appropriate walking state or running state can be realized.

In the security management system, for example, by a load sensor provided to a floor, the load distribution is detected when a person passes, and the body weight, stride, passing speed, shoe sole pattern, and the like are detected. Accordingly, the person who has passed can be identified by checking these pieces of detection information against data.

In the caregiving/nursing management system, for example, by load sensors provided to bedclothes and a toilet seat, the distributions of loads applied by a human body to the bedclothes and the toilet seat are monitored. Accordingly, at the positions of the bedclothes and the toilet seat, what action the person is going to take is estimated, whereby tumbling or falling can be prevented.

The load detection system of the embodiments below is applied to a management system as above, for example. The load detection system of the embodiments below includes: a plurality of load sensors each for detecting a load; and a detection circuit provided to each load sensor. The load sensor of the embodiments below is a capacitance-type load sensor. Such a load sensor may be referred to as a “capacitance-type pressure-sensitive sensor element”, a “capacitive pressure detection sensor element”, a “pressure-sensitive switch element”, or the like. The embodiments below are some embodiments of the present invention, and the present invention is not limited to the embodiments below in any way.

Hereinafter, embodiments of the present invention will be described with reference to the drawings. For convenience, X-, Y-, and Z-axes orthogonal to each other are indicated in the drawings. The Z-axis direction is the height direction of a load sensor 1.

### Embodiment 1

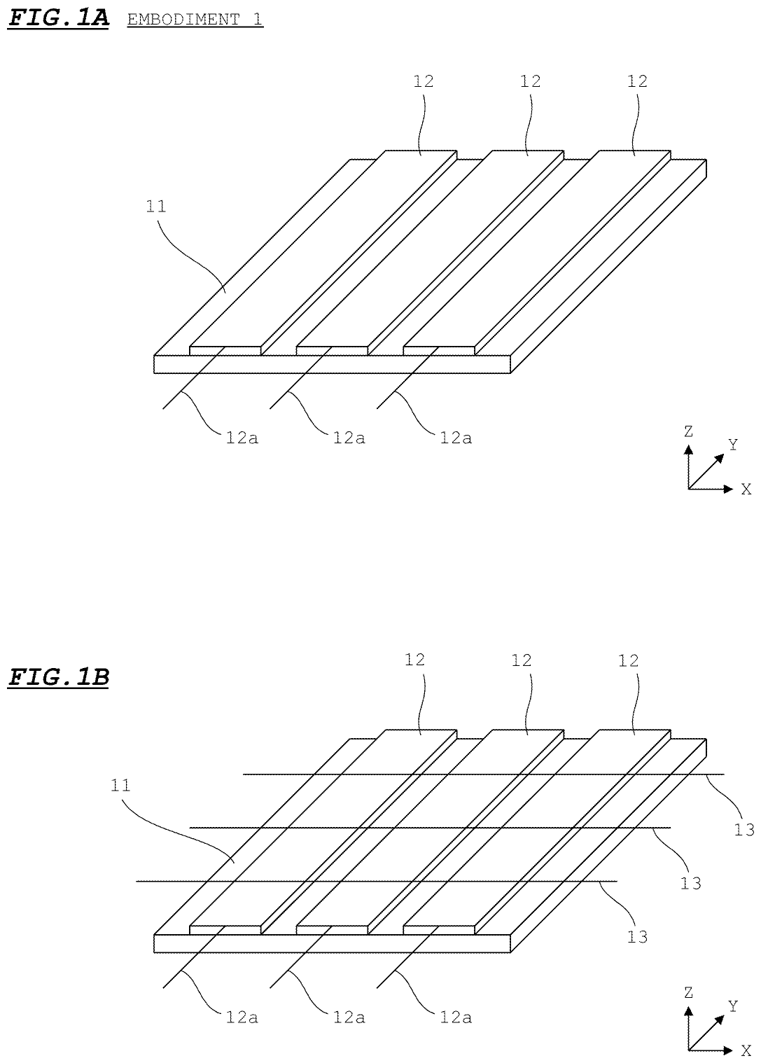

The load sensor 1 will be described with reference to FIG. 1A to FIG. 4.

FIG. 1A is a perspective view schematically showing a sheet-shaped member 11 and electrically-conductive elastic bodies 12 set on an opposing face (the face on the Z-axis positive side) of the sheet-shaped member 11.

The sheet-shaped member 11 is an insulative member having elasticity, and has a flat plate shape parallel to an X-Y plane. The thickness in the Z-axis direction of the sheet-shaped member 11 is 0.01 mm to 2 mm, for example.

The sheet-shaped member 11 is formed from a non-electrically-conductive resin material or a non-electrically-conductive rubber material. The resin material used in the sheet-shaped member 11 is a resin material of at least one type selected from the group consisting of a styrene-based resin, a silicone-based resin (e.g., polydimethylpolysiloxane (PDMS)), an acrylic resin, a rotaxane-based resin, a urethane-based resin, and the like, for example. The rubber material used in the sheet-shaped member 11 is a rubber material of at least one type selected from the group consisting of silicone rubber, isoprene rubber, butadiene rubber, styrene-butadiene rubber, chloroprene rubber, nitrile rubber, polyisobutylene, ethylene-propylene rubber, chlorosulfonated polyethylene, acrylic rubber, fluororubber, epichlorohydrin rubber, urethane rubber, natural rubber, and the like, for example.

The electrically-conductive elastic bodies 12 are formed on the opposing face (the face on the Z-axis positive side) of the sheet-shaped member 11. In FIG. 1A, three electrically-conductive elastic bodies 12 are formed on the opposing face of the sheet-shaped member 11. Each electrically-conductive elastic body 12 is an electrically-conductive member having elasticity. The electrically-conductive elastic bodies 12 each have a band-like shape that is long in the Y-axis direction, and are formed so as to be arranged with a predetermined interval therebetween in the X-axis direction. At an end portion on the Y-axis negative side of each electrically-conductive elastic body 12, a cable 12a electrically connected to the electrically-conductive elastic body 12 is set.

Each electrically-conductive elastic body 12 is formed on the opposing face of the sheet-shaped member 11 by a printing method such as screen printing, gravure printing, flexographic printing, offset printing, or gravure offset printing. With these printing methods, the electrically-conductive elastic body 12 can be formed so as to have a thickness of about 0.001 mm to 0.5 mm on the opposing face of the sheet-shaped member 11.

Each electrically-conductive elastic body 12 is formed from a resin material and an electrically-conductive filler dispersed therein, or from a rubber material and an electrically-conductive filler dispersed therein.

Similar to the resin material used in the sheet-shaped member 11 described above, the resin material used in the electrically-conductive elastic body 12 is a resin material of at least one type selected from the group consisting of a styrene-based resin, a silicone-based resin (e.g., polydimethylpolysiloxane (PDMS)), an acrylic resin, a rotaxane-based resin, a urethane-based resin, and the like, for example. Similar to the rubber material used in the sheet-shaped member 11 described above, the rubber material used in the electrically-conductive elastic body 12 is a rubber material of at least one type selected from the group consisting of silicone rubber, isoprene rubber, butadiene rubber, styrene-butadiene rubber, chloroprene rubber, nitrile rubber, polyisobutylene, ethylene-propylene rubber, chlorosulfonated polyethylene, acrylic rubber, fluororubber, epichlorohydrin rubber, urethane rubber, natural rubber, and the like, for example.

The electrically-conductive filler used in the electrically-conductive elastic body 12 is a material of at least one type selected from the group consisting of: metal materials such as Au (gold), Ag (silver), Cu (copper), C (carbon), ZnO (zinc oxide), In₂O₃ (indium oxide (III)), and SnO₂ (tin oxide (IV)); electrically-conductive macromolecule materials such as PEDOT:PSS (i.e., a complex composed of poly(3,4-ethylenedioxythiophene) (PEDOT) and polystyrene sulfonate (PSS)); and electrically-conductive fibers such as a metal-coated organic matter fiber and a metal wire (fiber state), for example.

FIG. 1B is a perspective view schematically showing a state where the conductor wires 13 are set on the structure in FIG. 1A.

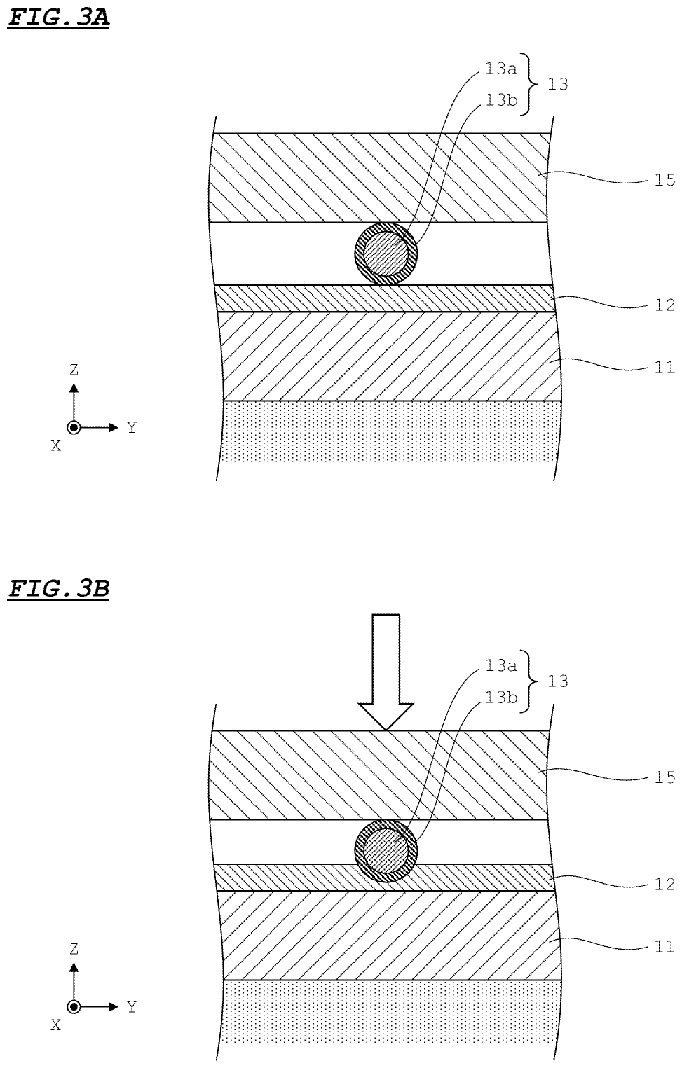

Each conductor wire 13 has a linear shape, and is disposed so as to be superposed on the upper faces of electrically-conductive elastic bodies 12 shown in FIG. 1A. In the example shown in FIG. 1B, three conductor wires 13 are disposed so as to be superposed on the upper faces of three electrically-conductive elastic bodies 12. The three conductor wires 13 are disposed so as to be arranged with a predetermined interval therebetween along the longitudinal direction (the Y-axis direction) of the electrically-conductive elastic bodies 12 so as to cross the electrically-conductive elastic bodies 12. Each conductor wire 13 is disposed, extending in the X-axis direction, so as to extend across the three electrically-conductive elastic bodies 12. The conductor wire 13 is a covered copper wire, for example. The conductor wire 13 is composed of an electrically-conductive member having a linear shape and a dielectric body formed on the surface of the electrically-conductive member. The configuration of the conductor wire 13 will be described later with reference to FIGS. 3A, 3B.

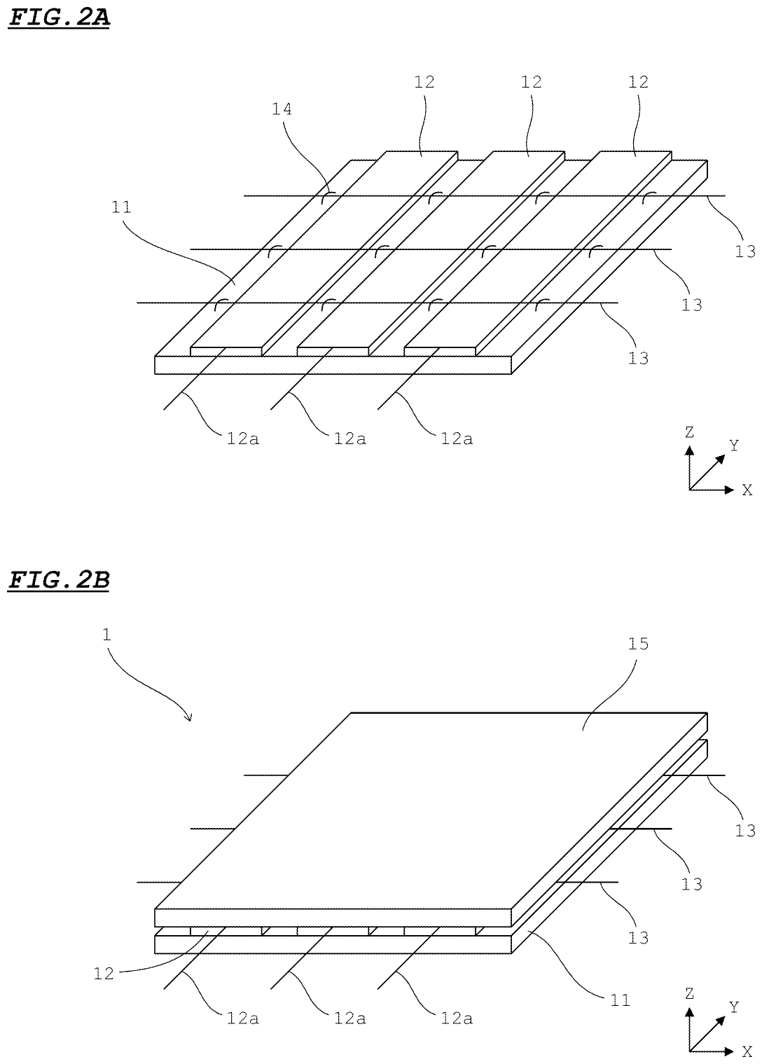

FIG. 2A is a perspective view schematically showing a state where threads 14 are set on the structure in FIG. 1B.

After the conductor wires 13 have been disposed as in FIG. 1B, each conductor wire 13 is connected to the sheet-shaped member 11 by threads 14 so as to be able to move in the longitudinal direction (the X-axis direction) of the conductor wire 13. In the example shown in FIG. 2A, twelve threads 14 connect the conductor wires 13 to the sheet-shaped member 11 at positions other than the positions where the electrically-conductive elastic bodies 12 and the conductor wires 13 overlap each other. Each thread 14 is implemented by a chemical fiber, a natural fiber, a mixed fiber of the chemical fiber and the natural fiber, or the like.

FIG. 2B is a perspective view schematically showing a state where a sheet-shaped member 15 is set on the structure in FIG. 2A.

The sheet-shaped member 15 is set from above (the Z-axis positive side) the structure shown in FIG. 2A. The sheet-shaped member 15 is an insulative member. The sheet-shaped member 15 is a resin material of at least one type selected from the group consisting of polyethylene terephthalate, polycarbonate, polyimide, and the like, for example. The sheet-shaped member 15 has a flat plate shape parallel to an X-Y plane, and has the same size and shape as those of the sheet-shaped member 11 in a plan view. The thickness in the Z-axis direction of the sheet-shaped member 15 is 0.01 mm to 2 mm, for example.

The outer peripheral four sides of the sheet-shaped member 15 are connected to the outer peripheral four sides of the sheet-shaped member 11 with a silicone-rubber-based adhesive, a thread, or the like, whereby the sheet-shaped member 11 and the sheet-shaped member 15 are fixed to each other. Accordingly, the conductor wires 13 are sandwiched by the electrically-conductive elastic bodies 12 and the sheet-shaped member 15. Accordingly, the load sensor 1 is completed as shown in FIG. 2B.

FIGS. 3A, 3B each schematically show a cross section of the electrically-conductive elastic body 12 and the conductor wire 13 along a plane parallel to a Y-Z plane at the center position in the X-axis direction of the electrically-conductive elastic body 12. FIG. 3A shows a state where no load is applied, and FIG. 3B shows a state where a load is applied. In FIGS. 3A, 3B, the face on the Z-axis negative side of the sheet-shaped member 11 is set on an installation surface.

As shown in FIGS. 3A, 3B, the conductor wire 13 is composed of an electrically-conductive member 13a and a dielectric body 13b formed on the electrically-conductive member 13a. The electrically-conductive member 13a is a wire member having a linear shape and the dielectric body 13b covers the surface of the electrically-conductive member 13a. The electrically-conductive member 13a is formed from copper, for example, and the diameter of the electrically-conductive member 13a is about 60 μm, for example. The dielectric body 13b has an electric insulation property, and is formed from a resin material, a ceramic material, a metal oxide material, or the like, for example. The dielectric body 13b may be a resin material of at least one type selected from the group consisting of a polypropylene resin, a polyester resin (e.g., polyethylene terephthalate resin), a polyimide resin, a polyphenylene sulfide resin, a polyvinyl formal resin, a polyurethane resin, a polyamide imide resin, a polyamide resin, and the like. Alternatively, the dielectric body 13b may be a metal oxide material of at least one type selected from the group consisting of Al₂O₃, Ta₂O₅, and the like.

As shown in FIG. 3A, when no load is applied, the force applied between the electrically-conductive elastic body 12 and the conductor wire 13, and the force applied between the sheet-shaped member 15 and the conductor wire 13 are each substantially zero. From this state, when a load is applied in the downward direction to the face on the Z-axis positive side of the sheet-shaped member 15 as shown in FIG. 3B, the electrically-conductive elastic body 12 and the sheet-shaped members 11, 15 are deformed by the conductor wire 13.

When a load is applied as shown in FIG. 3B, the conductor wire 13 is brought close to the electrically-conductive elastic body 12 so as to be wrapped by the electrically-conductive elastic body 12, and the contact area between the conductor wire 13 and the electrically-conductive elastic body 12 increases. Accordingly, the capacitance between the electrically-conductive member 13a and the electrically-conductive elastic body 12 changes. Then, the capacitance between the electrically-conductive member 13a and the electrically-conductive elastic body 12 is detected, whereby the load applied to this region is calculated.

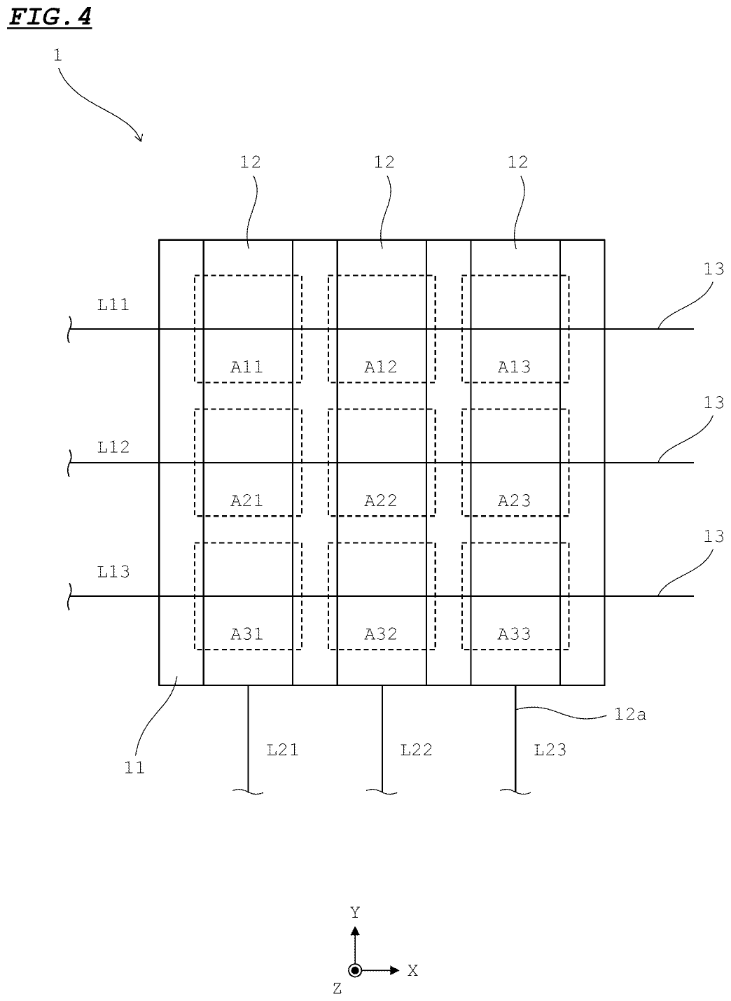

FIG. 4 is a plan view schematically showing a configuration of the inside of the load sensor 1. In FIG. 4, the threads 14 and the sheet-shaped member 15 are not shown, for convenience.

As shown in FIG. 4, element parts A11, A12, A13, A21, A22, A23, A31, A32, A33 in which the capacitance changes in accordance with a load are formed at positions where the three electrically-conductive elastic bodies 12 and the three conductor wires 13 cross each other. Each element part includes an electrically-conductive elastic body 12 and a conductor wire 13 in the vicinity of the intersection between the electrically-conductive elastic body 12 and the conductor wire 13.

In each element part, the conductor wire 13 forms one pole (e.g., positive pole) for capacitance, and the electrically-conductive elastic body 12 forms the other pole (e.g., negative pole) for capacitance. That is, the electrically-conductive member 13a (see FIGS. 3A, 3B) in the conductor wire 13 forms one electrode of the load sensor 1 (capacitance-type load sensor), the electrically-conductive elastic body 12 forms the other electrode of the load sensor 1 (capacitance-type load sensor), and the dielectric body 13b (see FIGS. 3A, 3B) in the conductor wire 13 corresponds to a dielectric body that defines the capacitance in the load sensor 1 (capacitance-type load sensor).

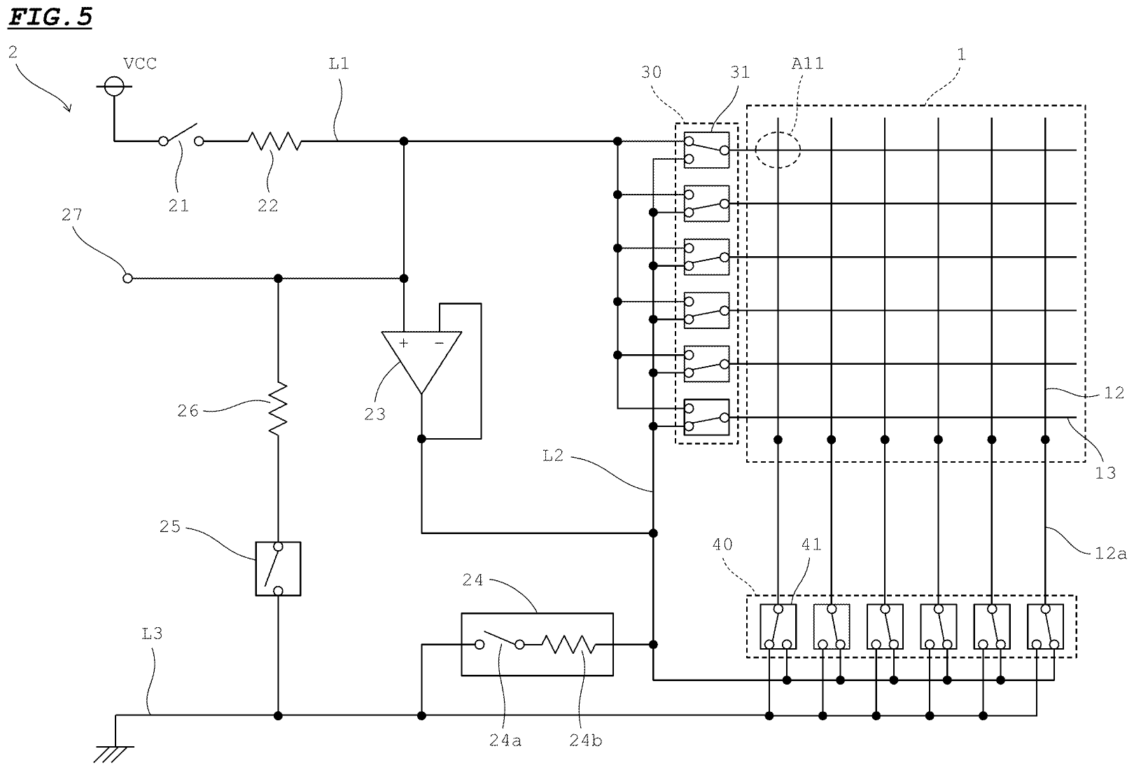

When a load is applied in the Z-axis direction to each element part, the conductor wire 13 is wrapped by the electrically-conductive elastic body 12. Accordingly, the contact area between the conductor wire 13 and the electrically-conductive elastic body 12 changes, and the capacitance between the conductor wire 13 and the electrically-conductive elastic body 12 changes. An end portion on the X-axis negative side of each conductor wire 13 and an end portion on the Y-axis negative side of the cable 12a set to each electrically-conductive elastic body 12 are connected to a detection circuit 2 described later with reference to FIG. 5.

As shown in FIG. 4, the electrically-conductive members 13a in the three conductor wires 13 will be referred to as lines L11, L12, L13, and the cables 12a drawn from the three electrically-conductive elastic bodies 12 will be referred to as lines L21, L22, L23. The positions at which the line L11 crosses the electrically-conductive elastic bodies 12 connected to the lines L21, L22, L23 are element parts A11, A12, A13, respectively. The positions at which the line L12 crosses the electrically-conductive elastic bodies 12 connected to the lines L21, L22, L23 are element parts A21, A22, A23, respectively. The positions at which the line L13 crosses the electrically-conductive elastic bodies 12 connected to the lines L21, L22, L23 are element parts A31, A32, A33, respectively.

When a load is applied to the element part A11, the contact area between the electrically-conductive member 13a in the conductor wire 13 and the electrically-conductive elastic body 12 increases via the dielectric body 13b in the element part A11. Therefore, when the capacitance between the line L11 and the line L21 is detected, the load applied to the element part A11 can be calculated. Similarly, in another element part as well, when the capacitance between two lines crossing each other in the other element part is detected, the load applied to the other element part can be calculated.

Next, a configuration of the detection circuit 2 electrically connected to the load sensor 1 will be described.

FIG. 5 is a circuit diagram showing a configuration of the detection circuit 2. In FIG. 5, for convenience, with respect to the load sensor 1, only the conductor wires 13 and the electrically-conductive elastic bodies 12 are shown, and the electrically-conductive elastic bodies 12 are each shown in a linear shape. In FIG. 5, the numbers of the conductor wires 13 and the electrically-conductive elastic bodies 12 are different from those in the example shown in FIG. 1A to FIG. 4, and are each six.

The detection circuit 2 includes a switch 21, a resistor 22, an equipotential generation part 23, switches 24, 25, a resistor 26, a voltage measurement terminal 27, a first switchover part 30, and a second switchover part 40. The detection circuit 2 is a circuit for detecting change in the capacitance at each crossing position between a conductor wire 13 and an electrically-conductive elastic body 12 with respect to the load sensor 1.

One terminal of the switch 21 is connected to a VCC power supply line of a load detection system 4 described later, and the other terminal of the switch 21 is connected to the resistor 22. The resistor 22 is disposed between the switch 21 and the plurality of the conductor wires 13. A first supply line L1 is connected to the downstream-side terminal of the resistor 22.

The first supply line L1 is connected to the first switchover part 30, the equipotential generation part 23, the resistor 26, and the voltage measurement terminal 27. The output-side terminal of the equipotential generation part 23 is connected to a second supply line L2. The equipotential generation part 23 is an operational amplifier, and the output-side terminal and the input-side negative terminal are connected to each other. The equipotential generation part 23 generates a suppression voltage that is equipotential to the potential (the potential on the downstream side of the resistor 22) of the first supply line L1.

The second supply line L2 is connected to the equipotential generation part 23, the first switchover part 30 and the second switchover part 40. The switch 24 is an electric element including a resistor component interposed between the second supply line L2 and a ground line L3. In FIG. 5, for convenience, the switching function of the switch 24 is shown as a switch part 24a, and the resistor component of the switch 24 is shown as a resistor part 24b. When the switch part 24a is set to an ON-state, the second supply line L2 is connected to the ground line L3 via the resistor part 24b.

The switch 25 is interposed between the first supply line L1 and the ground line L3. When the switch 25 is set to an ON-state, the first supply line L1 is connected to the ground line L3 via the resistor 26. The voltage measurement terminal 27 is connected to a signal processing circuit 113 described later.

The first switchover part 30 selectively connects either one of the first supply line L1 for supplying the potential on the downstream side of the resistor 22 and the second supply line L2 for supplying the suppression voltage, to the plurality of the conductor wires 13 (the electrically-conductive members 13a).

Specifically, the first switchover part 30 includes six multiplexers 31. The six multiplexers 31 are provided so as to correspond to the six conductor wires 13 (the electrically-conductive members 13a), respectively. To the output-side terminal of each multiplexer 31, the electrically-conductive member 13a of the conductor wire 13 is connected. Each multiplexer 31 is provided with two input-side terminals. The first supply line L1 is connected to one input-side terminal, and to this input-side terminal, a voltage is applied from the VCC power supply line via the resistor 22 and the first supply line L1. The other input-side terminal of the multiplexer 31 is connected to the second supply line L2, and to this input-side terminal, the suppression voltage is applied from the equipotential generation part 23 via the second supply line L2.

The second switchover part 40 selectively connects either one of the second supply line L2 for supplying the suppression voltage and the ground line L3 set to be equipotential to the ground, to the electrically-conductive elastic bodies 12 (the cables 12a).

Specifically, the second switchover part 40 includes six multiplexers 41. The six multiplexers 41 are provided so as to correspond to the six electrically-conductive elastic bodies 12 (the cables 12a), respectively. To the output-side terminal of each multiplexer 41, the cable 12a connected to the electrically-conductive elastic body 12 is connected. Each multiplexer 41 is provided with two input-side terminals. The second supply line L2 is connected to one input-side terminal, and to this input-side terminal, the suppression voltage is applied from the equipotential generation part 23 via the second supply line L2. The other input-side terminal of the multiplexer 41 is connected to the ground line L3.

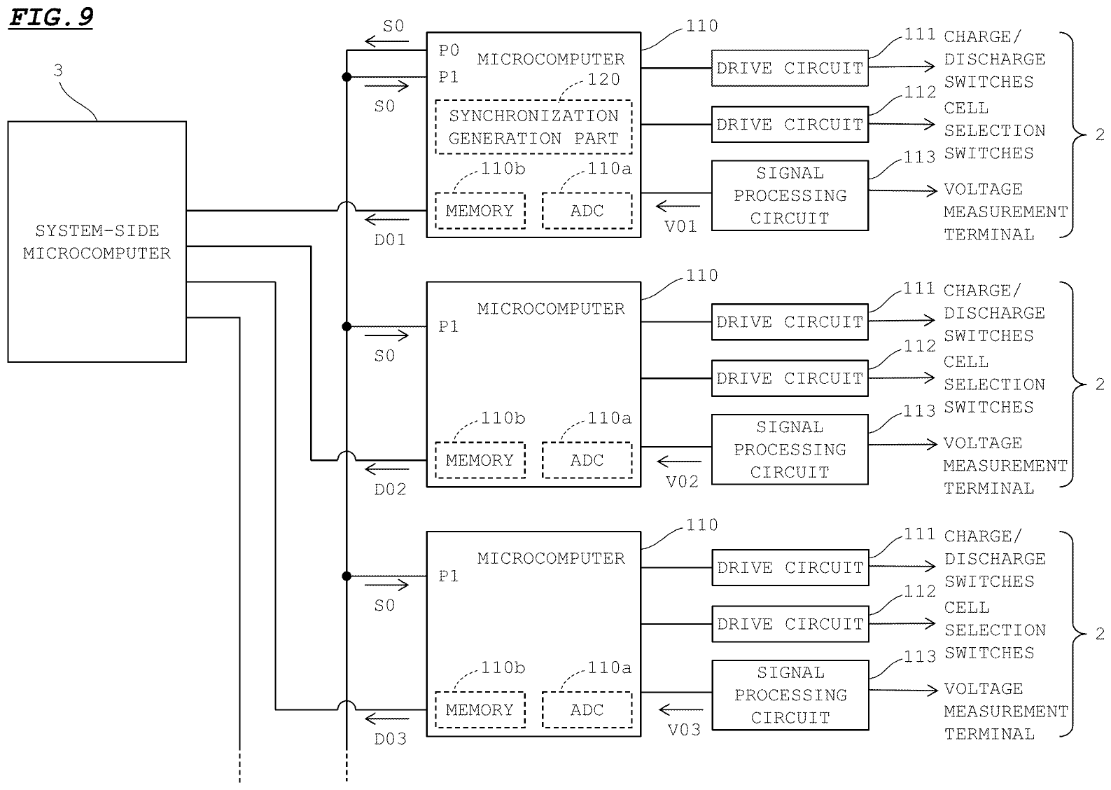

Switching of the switch 21, the switch part 24a, the switch 25, and the multiplexers 31, 41 are controlled by a microcomputer 110 (see FIG. 9) of the detection circuit 2 as described later.

Next, control of the detection circuit 2 during load detection will be described.

During load detection, as shown below, the microcomputer 110 (see FIG. 9) sequentially acquires the potential which changes in accordance with a load, with respect to each element part at the position where (36 places in the case of FIG. 5) a conductor wire 13 and an electrically-conductive elastic body 12 cross each other.

For example, a case where the potential is acquired with respect to the element part A11 at the position where the uppermost conductor wire 13 and the leftmost electrically-conductive elastic body 12 cross each other in FIG. 5, will be described.

When having set the element part A11 to be a measurement target, the microcomputer 110 performs switching of the multiplexer 31 connected to the conductor wire 13 (the electrically-conductive member 13a) forming an electrode of the element part A11, such that this multiplexer 31 is connected to the first supply line L1. In addition, the microcomputer 110 performs switching of the other five multiplexers 31 such that the other five multiplexers 31 are connected to the second supply line L2.

Further, the microcomputer 110 performs switching of the multiplexer 41 connected to the electrically-conductive elastic body 12 forming an electrode of the element part A11, such that this multiplexer 41 is connected to the ground line L3. In addition, the microcomputer 110 performs switching of the other five multiplexers 41 such that the other five multiplexers 41 are connected to the second supply line L2.

Further, the microcomputer 110 switches the switch part 24a and the switch 25 to an OFF-state.

Then, the microcomputer 110 sets the switch 21 to be ON for a predetermined time, and applies a rectangular voltage to the first supply line L1. Accordingly, charging of the element part A11 serving as the measurement target is started.

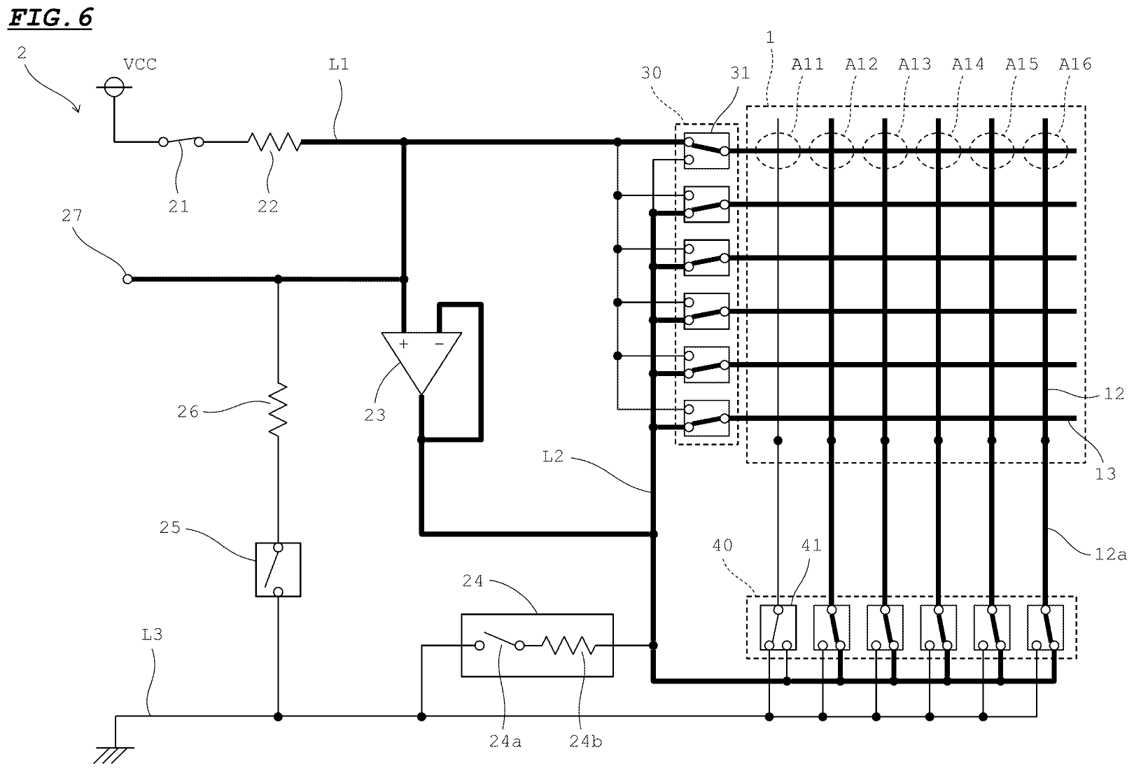

FIG. 6 is a circuit diagram schematically showing a state after the switch 21 has been set to an ON-state when the element part A11 is the measurement target. In FIG. 6, the thick lines show portions being equipotential to the potential of the first supply line L1.

As shown in FIG. 6, when the switch 21 has been set to an ON-state, a rectangular voltage is applied to the element part A11 serving as the measurement target via the resistor 22, and electric charge is charged to the element part A11 serving as the measurement target. In association with this, the potential of the element part A11 increases according to the time constant defined by the resistance value of the resistor 22 and the capacitance in the element part A11 according to the load. This potential is reflected in the potential of the first supply line L1. This potential is outputted to the microcomputer 110 via the voltage measurement terminal 27. At a predetermined timing (a measurement timing T2 described later) after charging has been started, the microcomputer 110 acquires a potential via the voltage measurement terminal 27 and stores the acquired potential.

At this time, to the negative pole side of the other element parts A12 to A16 in the same row (the same conductor wire 13) as the element part A11 serving as the measurement target, the potential from the equipotential generation part 23 is applied, and thus, the positive poles and the negative poles become equipotential to each other. Therefore, electric charge is not accumulated in the other element parts A12 to A16, thus, electric charge is appropriately accumulated in the element part A11 serving as the measurement target, and the voltage of the element part A11 is accurately measured. To the positive poles and the negative poles of the other element parts in the same columns (the same electrically-conductive elastic bodies 12) as the element parts A12 to A16, the potential from the equipotential generation part 23 is applied, and thus, electric charge is not accumulated in these other element parts, either. Therefore, these element parts can be disabled in measurement.

To the positive poles of the other element parts in the same column (the same electrically-conductive elastic body 12) as the element part A11 serving as the measurement target, the potential from the equipotential generation part 23 is applied, and the negative poles of these other element parts are connected to the ground line L3. Therefore, electric charge is accumulated in these other element parts. However, since the positive poles of these element parts are disconnected from the first supply line L1, the electric charge accumulated in these other element parts do not influence measurement of the potential of the element part A11.

Upon acquiring the potential with respect to the element part A11 serving as the measurement target, the microcomputer 110 switches the switch 21 to an OFF-state at a predetermined timing (a discharge start timing T3 described later). Then, the microcomputer 110 switches the switch part 24a to an ON-state such that the second supply line L2 and the ground line L3 are connected to each other, and switches the switch 25 to an ON-state such that the first supply line L1 and the ground line L3 are connected to each other. Accordingly, the electric charge accumulated in each element part is discharged.

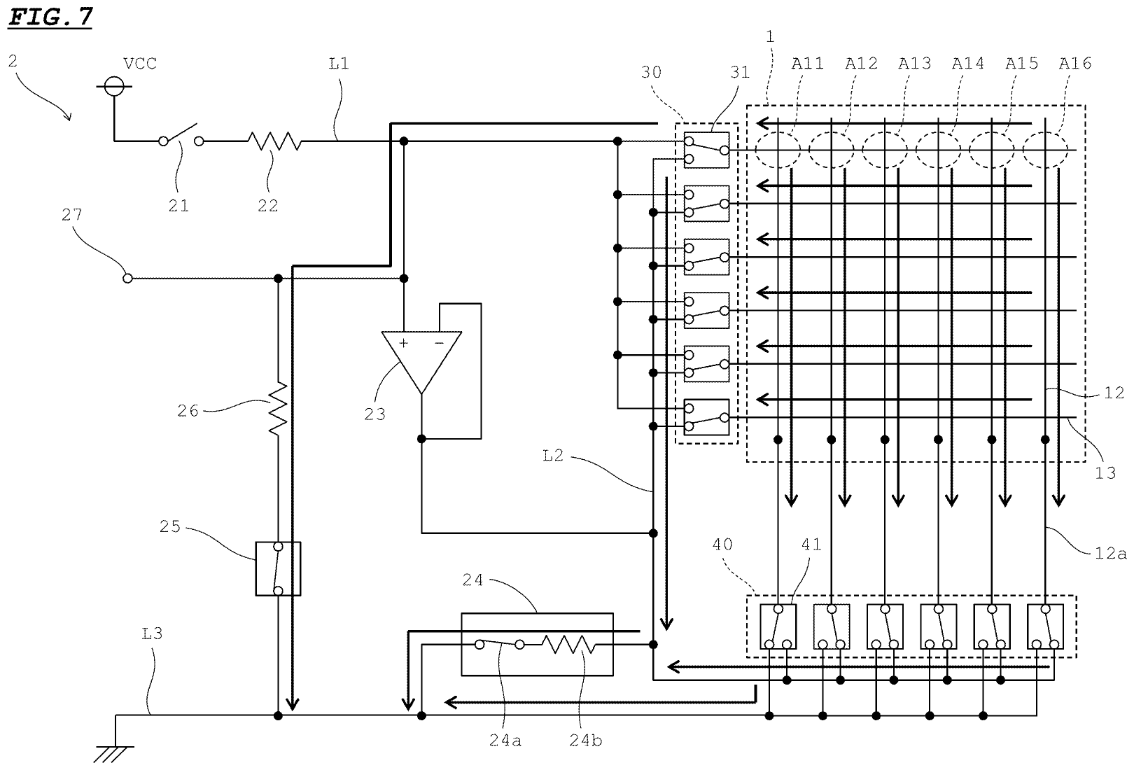

FIG. 7 is a circuit diagram schematically showing a state where discharging is performed through switching of the switch 21, the switch part 24a, and the switch 25 from the state in FIG. 6.

Through the switching performed as shown in FIG. 7, the conductor wire 13 where the element part A11 having served as the measurement target is positioned is connected to the ground line L3 via the resistor 26 and the switch 25. The conductor wires 13 different from the conductor wire 13 where the element part A11 is positioned, and the electrically-conductive elastic bodies 12 that are the same as the electrically-conductive elastic bodies 12 where the element parts A12 to A16 are positioned, are connected to the ground line L3 via the switch 24. Accordingly, the electric charge accumulated in all the element parts is discharged.

Then, in order to set the next element part to be the measurement target, the microcomputer 110 sets the connection states of the multiplexers 31, 41, and switches the switch part 24a and the switch 25 to an OFF-state and switches the switch 21 to an ON-state, as in FIG. 6.

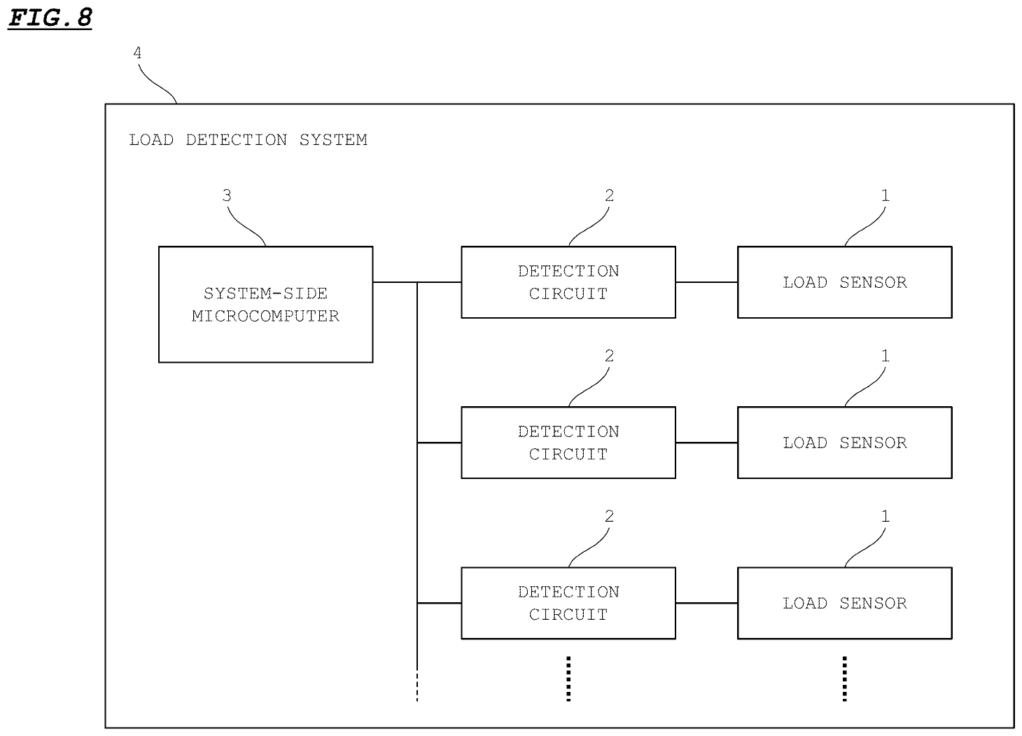

In this manner, the microcomputer 110 sequentially acquires and stores the potential with respect to each element part. When having acquired and stored the potentials with respect to all the element parts, the microcomputer 110 transmits the potential of each element part to a system-side microcomputer 3 (see FIG. 8).

FIG. 8 is a block diagram showing a configuration of the load detection system 4.

The load detection system 4 includes: a plurality of the load sensors 1; a plurality of the detection circuits 2 respectively connected to the plurality of the load sensors 1; and the system-side microcomputer 3.

The plurality of the load sensors 1 are disposed so as to be spread in a plane direction in accordance with the entire load detection range of the load detection system 4. For example, the plurality of the load sensors 1 are disposed in a state of being arranged in one direction, or in a matrix shape. The plurality of the load sensors 1 need not necessarily be disposed adjacent to each other, and, for example, when the load detection range of the load detection system 4 is separated, the plurality of the load sensors 1 may be disposed in a state of being separated from each other.

The detection circuit 2 includes the circuit system in FIG. 5, and controls the switches and the like for the load sensor 1. In addition, the detection circuit 2 sequentially acquires a potential signal of each element part, acquired via the voltage measurement terminal 27, of the corresponding load sensor 1, and performs AD conversion on the acquired potential signals to generate potential data. In response to having acquired the potential signals of all the element parts, the detection circuit 2 transmits the potential data of all the element parts to the system-side microcomputer 3.

The system-side microcomputer 3 receives the potential data sent from the plurality of the detection circuits 2, and calculates the capacitance of each element part of the plurality of the load sensors 1, based on the potential, the time constant, and the voltage value of the rectangular voltage. Then, based on the capacitance of each element part, the system-side microcomputer 3 calculates the load applied to each element part. In this manner, the loads applied to all the element parts of the plurality of the load sensors 1 are calculated.

FIG. 9 schematically shows configurations of a plurality of the detection circuits 2 and the system-side microcomputer 3, and transmission/reception of signals. In FIG. 9, three detection circuits 2 out of n (n is an integer of 2 or greater) detection circuits 2 are shown.

Each detection circuit 2 includes the microcomputer 110, drive circuits 111, 112, and the signal processing circuit 113, in addition to the circuit system in FIG. 5.

The microcomputer 110 includes an arithmetic processing circuit, and is implemented by an FPGA or an MPU, for example. The microcomputer 110 includes an ADC 110a and a memory 110b. The memory 110b has stored therein programs of processes performed in the microcomputer 110, and the like. The microcomputer 110 executes various types of processes in accordance with the programs in the memory 110b.

One microcomputer 110 (the uppermost microcomputer 110 in FIG. 9) out of a plurality of the microcomputers 110 has a synchronization generation part 120. This microcomputer 110 executes the function of the synchronization generation part 120 according to a program stored in the memory 110b. The other microcomputers 110 do not have the synchronization generation part 120. However, the synchronization generation part 120 may be provided in a microcomputer 110 other than this microcomputer 110.

The drive circuit 111 performs switching of charge/discharge switches (the switch 21, the switch part 24a, and the switch 25 shown in FIG. 5) for the corresponding load sensor 1 in accordance with an instruction from the microcomputer 110. The drive circuit 112 performs switching of cell selection switches (the first switchover part 30 and the second switchover part 40 shown in FIG. 5) for the corresponding load sensor 1 in accordance with an instruction from the microcomputer 110. The signal processing circuit 113 is connected to the voltage measurement terminal 27 (see FIG. 5) for the corresponding load sensor 1 and performs amplification and noise removal on the potential signal from the voltage measurement terminal 27. The signal processing circuit 113 has a capacitor, for example, as a configuration for the noise removal regarding the potential signal.

The ADC 110a converts an analog potential signal V0n inputted from the corresponding signal processing circuit 113, into digital data. The digital potential data generated through the conversion by the ADC 110a is sequentially stored into the memory 110b. When the potential data with respect to all the element parts of the corresponding load sensor 1 has been stored into the memory 110b, the microcomputer 110 transmits potential data D0n with respect to all the element parts, to the system-side microcomputer 3.

The microcomputer 110 of each detection circuit 2 is connected to the system-side microcomputer 3. In addition, the uppermost microcomputer 110 having the synchronization generation part 120 includes a port P0 for transmitting a synchronization signal S0 described later, and all the microcomputers 110 include a port P1 to which the synchronization signal S0 is inputted.

The system-side microcomputer 3 includes an arithmetic processing circuit, and is implemented by an FPGA or an MPU, for example. The system-side microcomputer 3 calculates the load applied to each element part of the plurality of the load sensors 1, based on the potential data D0n sent from the plurality of the detection circuits 2.

Here, when the process of acquiring the potential is performed with respect to the element parts of the load sensors 1, the microcomputer 110 having the synchronization generation part 120 outputs the synchronization signal S0 for instructing start of charging of the element parts, from the port P0 to the port P1 of all the microcomputers 110, according to the function of the synchronization generation part 120. Using this synchronization signal S0 having been inputted to the port P1 as a trigger, each microcomputer 110 starts the process (charging, measurement, discharging, and switching) with respect to an element part. Accordingly, the processes in the respective detection circuits 2 are performed in synchronization with each other.

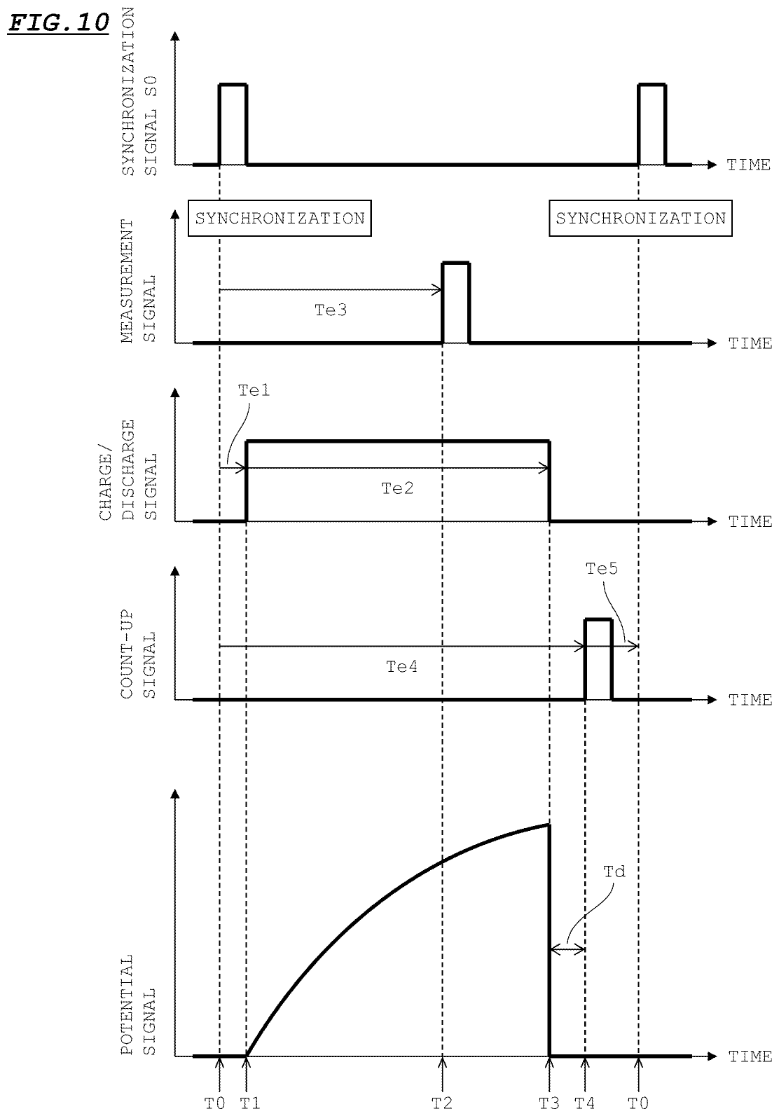

FIG. 10 is a time chart showing states of the synchronization signal S0, a measurement signal, a charge/discharge signal, a count-up signal, and the potential signal V0n outputted from the signal processing circuit 113 to the microcomputer 110 in each detection circuit 2. The horizontal axis of each graph represents elapsed time.

When the microcomputer 110 has received the synchronization signal S0 at a synchronization timing TO, the microcomputer 110 raises the charge/discharge signal to be supplied to the drive circuit 111, at a charge start timing T1 after an elapsed time Te1 from the synchronization timing TO. Further, the microcomputer 110 lowers the charge/discharge signal at the discharge start timing T3 after an elapsed time Te2 from the charge start timing T1. The drive circuit 111 performs switching of the charge/discharge switches (the switch 21, the switch part 24a, and the switch 25 in FIG. 5) in accordance with the charge/discharge signal. Specifically, at the charge start timing T1, the drive circuit 111 sets the switch 21 to an ON-state, and maintains the OFF-state of the switch part 24a and the switch 25. Then, at the discharge start timing T3, the drive circuit 111 sets the switch 21 to an OFF-state, and sets the switch part 24a and the switch 25 to an ON-state.

Further, after having received the synchronization signal S0 at the synchronization timing TO, the microcomputer 110 outputs the measurement signal to the ADC 110a at the measurement timing T2 after an elapsed time Te3 from the synchronization timing TO. The ADC 110a measures the potential at the voltage measurement terminal 27 in accordance with the measurement signal. Specifically, the signal processing circuit 113 is always performing amplification and noise removal on the potential signal from the voltage measurement terminal 27 and outputting the processed potential signal V0n to the microcomputer 110. The ADC 110a converts the potential signal V0n into digital potential data at the measurement timing T2 at which the measurement signal has been received, and stores the potential data into the memory 110b.

Further, after having received the synchronization signal S0 at the synchronization timing TO, the microcomputer 110 outputs the count-up signal to the drive circuit 112 at a switching timing T4 after an elapsed time Te4 from the synchronization timing TO. In response to reception of the count-up signal, the drive circuit 112 increments a counter by one, and performs switching of the cell selection switches (the first switchover part 30 and the second switchover part 40 in FIG. 5) such that an element part corresponding to the count value of the counter becomes the measurement target regarding the potential signal.

Specifically, the drive circuit 112 includes a counter that counts the count-up signal up to the total number of the element parts included in the load sensor 1 and then returns to 1 upon arrival of the next count-up signal. The initial value of the counter is 1. Meanwhile, the count value of the counter is associated with the cell number of each element part. For example, in the load sensor 1 in FIG. 5, the cell number of the element part A11 at the upper left corner is 1, and the cell number of the element part at the lower right corner is 36. The drive circuit 112 increments the counter by one in response to reception of the count-up signal, and switches the cell selection switches (the first switchover part 30 and the second switchover part 40 in FIG. 5) such that, at the next potential signal measurement, an element part having the next cell number becomes the measurement target regarding the potential signal. In this manner, at the switching timing T4, charging/discharging of the element part that is to be the next measurement target is prepared.

The microcomputer 110 lowers the charge/discharge signal at the discharge start timing T3, and then, outputs the count-up signal at the switching timing T4 after elapse of a discharge period Td. The discharge period Td at this time is set to be slightly longer than the longest discharge period defined by: the electric charge amount that can be charged to the element part; and the resistor part 24b and the resistor 26. Accordingly, after the discharging has been assuredly completed, switching to the element part to be measured next and measurement on the next element part can be performed.

When the measurement process on one element part has ended through the above process, the uppermost microcomputer 110 in FIG. 9 outputs the synchronization signal S0 after an elapsed time Te5 from the output of the count-up signal in FIG. 10. Upon receiving the synchronization signal S0 outputted from the uppermost microcomputer 110, all the microcomputers 110 perform the measurement process similar to the above on the element part that is to be the next measurement target. That is, every time each microcomputer 110 receives the synchronization signal S0, the microcomputer 110 transmits/receives the signals as above, and performs the process on the element part serving as the measurement target. Then, in accordance with the count-up signal, the element part serving as the measurement target is changed to the next element part. Then, upon receiving the synchronization signal S0, the microcomputer 110 performs the process on the next element part, similarly to the above.

When the measurement on all the element parts of the corresponding load sensor 1 has ended, the microcomputer 110 transmits, as the potential data D0n (see FIG. 9), measurement values of all the element parts stored in the memory 110b to the system-side microcomputer 3. Then, the microcomputer 110 changes the measurement target to the first element part, and performs measurement on each element part, similarly to the above.

Here, Comparative Example in which, without using the synchronization signal S0, all the microcomputers 110 respectively perform the process (charging, measurement, discharging, and switching) with respect to an element part at individual timings will be described.

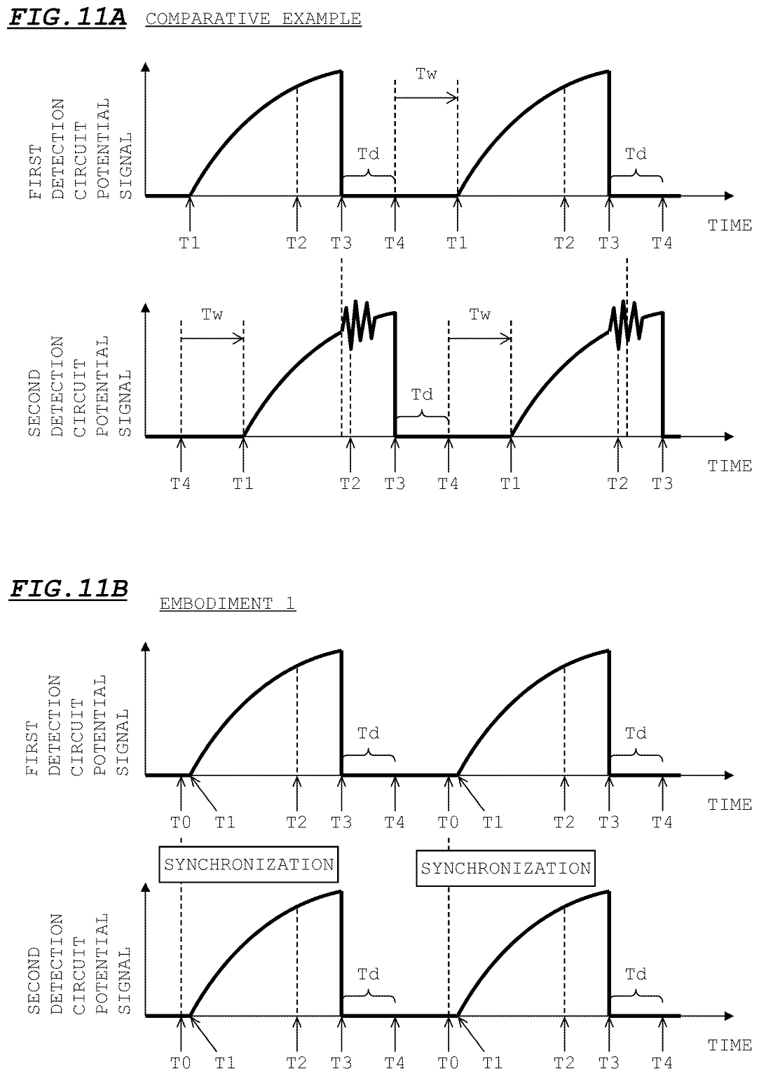

FIG. 11A is a graph schematically showing the potential signal V0n acquired by the detection circuit 2 according to Comparative Example. FIG. 11B is a graph schematically showing the potential signal V0n acquired by the detection circuit 2 according to Embodiment 1. In FIGS. 11A, 11B, the potential signals V0n of one detection circuit 2 (a first detection circuit) and another detection circuit (a second detection circuit) out of the plurality of the detection circuits 2 are shown.

In Comparative Example, after activation of the load detection system 4, the microcomputer 110 of the first detection circuit and the microcomputer 110 of the second detection circuit each start the load detection process on a corresponding load sensor 1 in accordance with a measurement start instruction from the system-side microcomputer 3. At this time, each microcomputer 110 sets the timing at which a certain time Tw has elapsed from the switching timing T4, to be the charge start timing T1 of the next measurement cycle, and performs the measurement process on the next element part. In this manner, the microcomputers 110 of the first detection circuit and the second detection circuit respectively and repeatedly execute a series of measurement cycles until receiving a measurement end instruction from the system-side microcomputer 3.

However, in the case of Comparative Example, when the process of a series of measurement cycles is repeatedly performed in each microcomputer 110, slight differences in the processing speed of the respective microcomputers 110 are accumulated, whereby variation may be caused in the timing of the process as shown in FIG. 11A. In this case, for example, due to discharging performed by the first detection circuit, noise may be superposed on the potential signal acquired by the second detection circuit.

That is, when a plurality of the detection circuits 2 are integrated in a single circuit system, noise caused by discharging performed by the first detection circuit may propagate to the second detection circuit via the power supply line, the ground line, and the like that are used in common between the respective detection circuits 2.

As described above, in Comparative Example, variation is caused in the processing timing of the microcomputers 110. Thus, for example, as shown in FIG. 11A, the discharge start timing T3 of the first detection circuit and the measurement timing T2 of the second detection circuit may become close to each other. In this case, if noise caused by discharging performed by the first detection circuit propagates to the second detection circuit, noise may be superposed on the potential signal in the second detection circuit at the measurement timing T2 of the second detection circuit, whereby the load detection accuracy based on the second detection circuit may decrease. Such noise may fail to be sufficiently removed by the noise removal performed by the signal processing circuit 113 in FIG. 9.

In contrast to this, in Embodiment 1, as described above, before charging the element part to serve as the target, the microcomputer 110 of a predetermined detection circuit 2 transmits the synchronization signal S0 to all the microcomputers 110 including this microcomputer 110, and each microcomputer 110 performs the process of charging, measurement, discharging, and switching with respect to an element part at a timing based on the synchronization signal S0. Accordingly, even if the processes on element parts are repeatedly performed, the timings of charging, measurement, discharging, and switching in the first detection circuit and the second detection circuit are substantially aligned with each other as shown in FIG. 11B. Therefore, it is possible to prevent noise having occurred from the first detection circuit from being superposed on the potential signal in the second detection circuit at the measurement timing T2 of the second detection circuit. Thus, the load detection accuracy based on the second detection circuit can be maintained to be high.

As described above, the synchronization signal S0 is outputted after elapse of a certain period from the switching timing T4 of one cycle before, in the microcomputer 110 that transmits the synchronization signal S0. Therefore, even when a slight time difference has occurred in the switching timing T4 between the microcomputer 110 that transmits the synchronization signal S0 and the other microcomputers 110, the synchronization signal S0 is outputted after switching of the element parts has been assuredly performed in the other microcomputers 110. Therefore, charging and measurement can be appropriately performed in all the load sensors 1.

<Effects of Embodiment 1>

According to Embodiment 1, the following effects are exhibited.

As described with reference to FIG. 11B, charging of the element part (a first element part) of one load sensor 1 (a first load sensor) by the one detection circuit 2 (the first detection circuit) and charging of the element part (a second element part) of another load sensor 1 (a second load sensor) by another detection circuit 2 (the second detection circuit) are synchronized with each other in accordance with the synchronization signal S0 from the synchronization generation part 120. Therefore, overlapping of the discharge period for the element part of the one load sensor 1 (the first load sensor) with the detection timing for the element part of the other load sensor 1 (the second load sensor) can be avoided. Therefore, the voltage acquired by the other detection circuit (the second detection circuit) can be suppressed from being influenced by noise from the one detection circuit (the first detection circuit). Therefore, the load applied to each element part of the one load sensor 1 (the first load sensor) and the other load sensor 1 (the second load sensor) can be accurately measured.

The one load sensor 1 (the first load sensor) includes a plurality of the element parts (the first element parts). After the discharge period Td (see FIG. 11B) for the first element part serving as the detection target, the one detection circuit 2 (the first detection circuit) sequentially switches the detection target to the next first element part, to acquire a voltage (the potential signal V0n). The other load sensor 1 (the second load sensor) includes a plurality of the element parts (the second element parts). After the discharge period Td for the second element part serving as the detection target, the other detection circuit 2 (the second detection circuit) sequentially switches the detection target to the next second element part, to acquire a voltage (the potential signal V0n). With this configuration, the plurality of the element parts are disposed to each of the first load sensor and the second load sensor, and thus, the load distribution can be detected with a predetermined resolving power.

Every time the element part serving as the detection target is switched, the synchronization generation part 120 outputs, to each of the first detection circuit and the second detection circuit, the synchronization signal S0 (see FIGS. 9, 10) for synchronizing charging of the first element part and charging of the second element part with each other. With this configuration, every time the detection target is switched, charging of the first element part and charging of the second element part are synchronized with each other. Therefore, overlapping of the discharge period Td for one element part with the detection timing for the other element part can be more assuredly avoided. Therefore, the voltage acquired by the other detection circuit 2 can be more assuredly suppressed from being influenced by noise from the one detection circuit 2.

The synchronization generation part 120 is disposed in the one detection circuit 2 (the first detection circuit) out of a plurality of the detection circuits 2. With this configuration, the signal that is used for starting charging in the first detection circuit can be used, as is, for starting charging in the second detection circuit. Therefore, with a simple configuration, charging of the first element part of the first load sensor and charging of the second element part of the second load sensor can be synchronized with each other.

The number of the first element parts disposed in the first load sensor and the number of the second element parts disposed in the second load sensor are identical to each other. In Embodiment 1, in all the load sensors 1, the numbers (36 in FIG. 5) of the element parts are identical to each other. With this configuration, the process on the first load sensor and the process on the second load sensor can be made similar processes, and the processes can be simplified.

### Embodiment 2

In Embodiment 1, the synchronization generation part 120 is disposed in one microcomputer 110 out of the plurality of the microcomputers 110. However, in Embodiment 2, the synchronization generation part 120 is disposed in the system-side microcomputer 3.

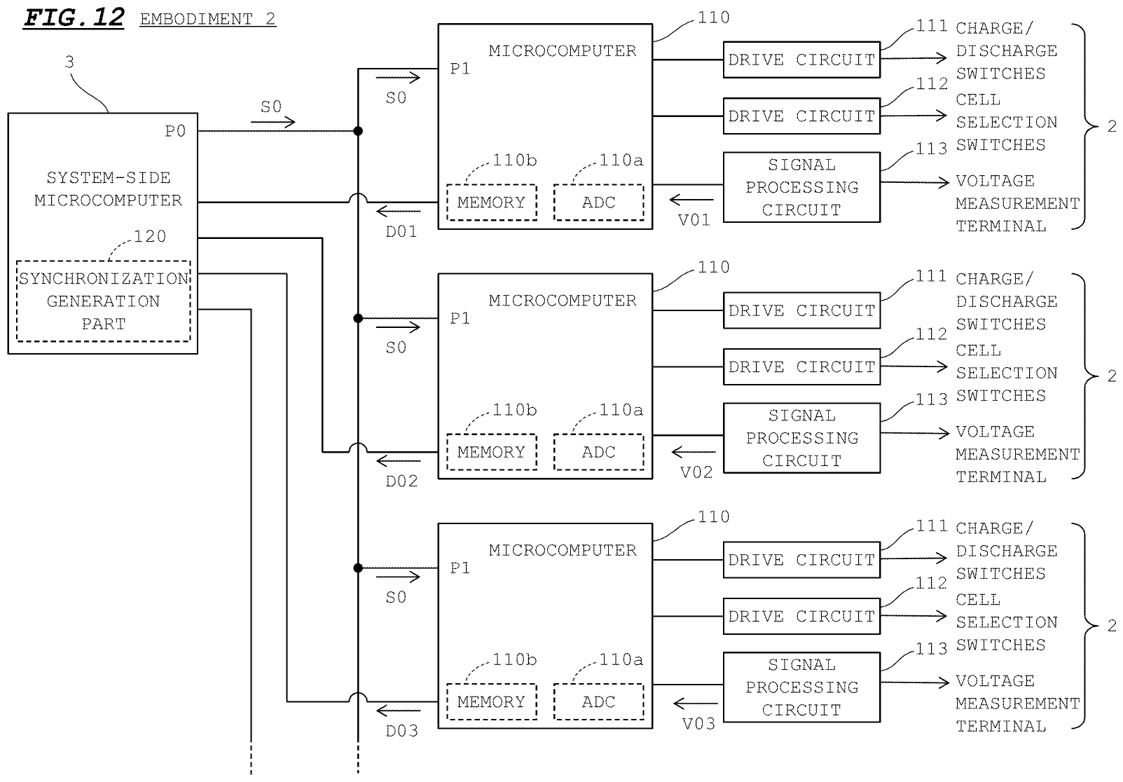

FIG. 12 schematically shows configurations of a plurality of the detection circuits 2 and the system-side microcomputer 3, and transmission/reception of signals, according to Embodiment 2.

In Embodiment 2, as compared with Embodiment 1, the synchronization generation part 120 is provided in the system-side microcomputer 3. The system-side microcomputer 3 executes the function of the synchronization generation part 120 according to a program stored in a memory (not shown) of the system-side microcomputer 3. The port P0 of the system-side microcomputer 3 is connected to the port P1 of each microcomputer 110.

In Embodiment 2, the synchronization generation part 120 of the system-side microcomputer 3 transmits the synchronization signal S0 from the port P0 of the system-side microcomputer 3 to the port P1 of all the microcomputers 110, at a predetermined time interval, i.e., the time interval of one measurement cycle shown in Embodiment 1 above. In accordance with the received synchronization signal S0, each microcomputer 110 performs the process of charging, measurement, discharging, and switching with respect to an element part, as in Embodiment 1.

According to Embodiment 2, all the detection circuits 2 can have the same configuration from which the synchronization generation part 120 is omitted, and thus, the cost of the detection circuit 2 can be reduced.

### Embodiment 3

In Embodiment 1, the potential data D0n is transmitted from all the microcomputers 110 to the system-side microcomputer 3. However, in Embodiment 3, potential data is transferred to one microcomputer 110 from the other microcomputers 110, and then, the potential data of each microcomputer 110 is transmitted to the system-side microcomputer 3.

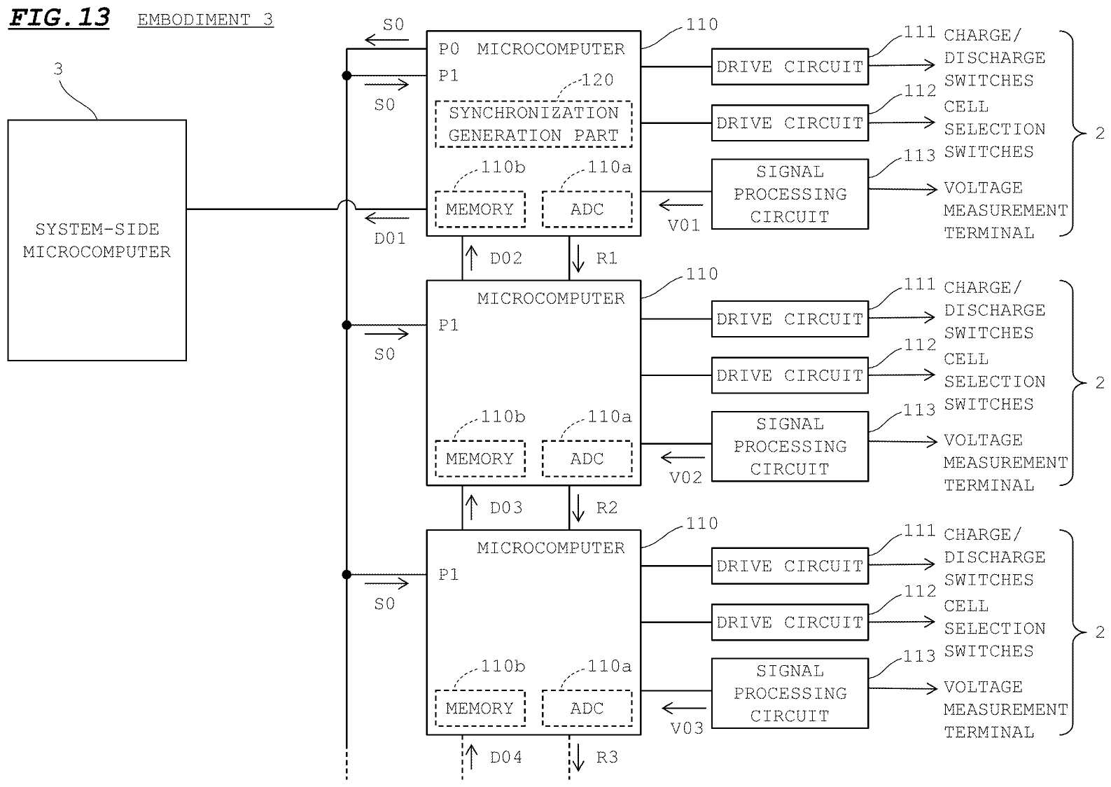

FIG. 13 schematically shows configurations of a plurality of the detection circuits 2 and the system-side microcomputer 3, and transmission/reception of signals, according to Embodiment 3.

In Embodiment 3, as compared with Embodiment 1, only the microcomputer 110 that has the synchronization generation part 120 is connected to the system-side microcomputer 3 in order to transfer the potential data. Adjacent microcomputers 110 are connected to each other in order to transmit/receive a transfer request signal Rn/the potential data D0n.

When the microcomputer 110 connected to the system-side microcomputer 3 has acquired the potential data of all the element parts, the microcomputer 110 transmits the potential data D0n to the system-side microcomputer 3, and transmits the transfer request signal Rn to a microcomputer 110 adjacent to the microcomputer 110 on the downstream side viewed from the system-side microcomputer 3. The microcomputer 110 that has received the transfer request signal Rn transmits the potential data D0n of all the element parts stored in the memory 110b, to the microcomputer 110 adjacent on the upstream side, and transmits the transfer request signal Rn to a microcomputer 110 adjacent on the downstream side. In this manner, the potential data D0n acquired in each microcomputer 110 is transmitted one after another by each microcomputer 110 to the upstream side, and then transmitted from the uppermost microcomputer 110 to the system-side microcomputer 3. Accordingly the potential data D0n acquired in all the microcomputers 110 is transmitted to the system-side microcomputer 3.

The column composed of the plurality of the microcomputers 110 shown in FIG. 13 may be disposed so as to be arranged side by side, and the uppermost microcomputers 110 may be connected to each other in order to transfer the potential data. In this case, similar to the above, the potential data of the microcomputers 110 in another column is sequentially transferred to the microcomputers 110 on the upstream side, then, is transferred to the microcomputer 110 connected to the system-side microcomputer 3, and is transmitted from this microcomputer 110 to the system-side microcomputer 3.

### Embodiment 4

In Embodiment 2, the microcomputer 110 is disposed in each detection circuit 2. However, in Embodiment 4, the microcomputer 110 is omitted from each detection circuit 2 and the process in each detection circuit 2 is realized by hardware (circuit).

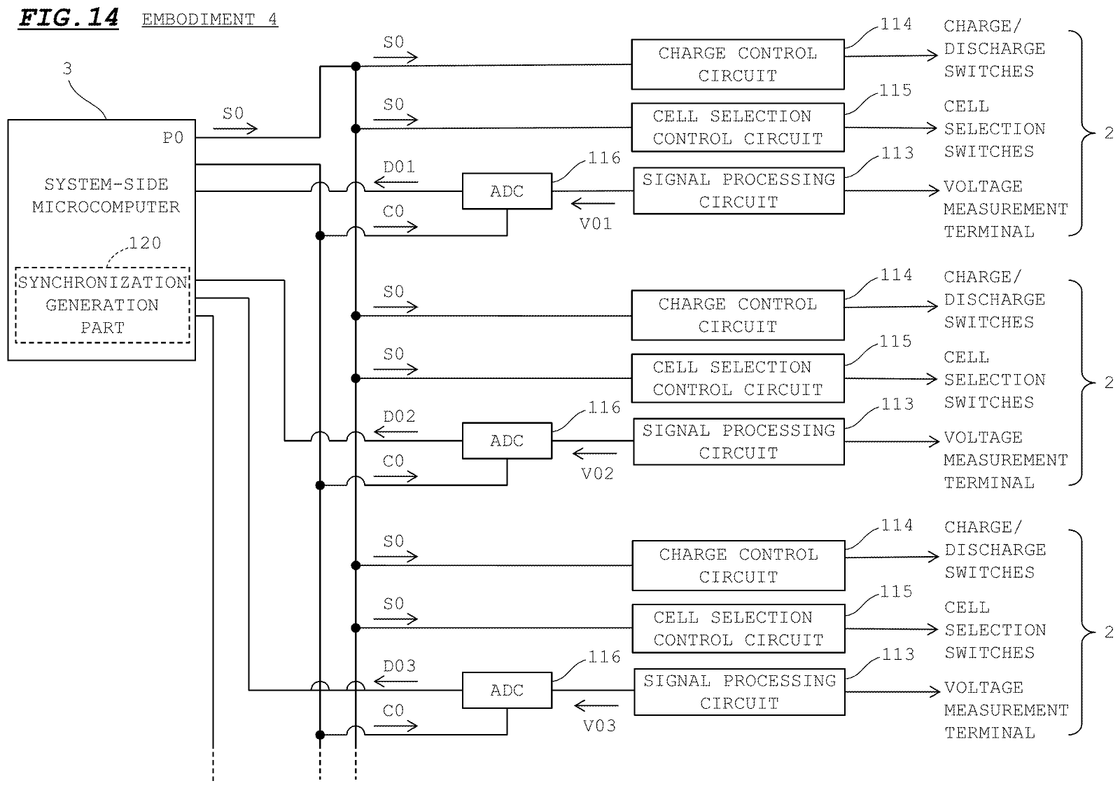

FIG. 14 schematically shows configurations of a plurality of the detection circuits 2 and the system-side microcomputer 3, and transmission/reception of signals, according to Embodiment 4.

In Embodiment 4, as compared with Embodiment 2, the microcomputer 110 and the drive circuits 111, 112 are omitted, and a charge control circuit 114, a cell selection control circuit 115, and an ADC 116 are added. The charge control circuit 114 and the cell selection control circuit 115 are connected to the port P0 of the system-side microcomputer 3. The ADC 116 is connected to the system-side microcomputer 3 in order to transmit the potential data D0n, and is connected to the system-side microcomputer 3 in order to receive a measurement signal CO described later. The ADC 116 is also connected to the signal processing circuit 113.

Similar to the case in FIG. 12, the synchronization generation part 120 of the system-side microcomputer 3 transmits the synchronization signal S0 to all the charge control circuits 114 and all the cell selection control circuits 115 at the synchronization timing TO (see FIG. 10). Using the received synchronization signal S0 as a reference, the charge control circuit 114 sets the charge start timing T1 and the discharge start timing T3 in FIG. 10, and performs switching of the charge/discharge switches (the switches 21, 24, 25 in FIG. 5) such that charging/discharging of the element part serving as the measurement target is performed at the charge start timing T1/the discharge start timing T3 that have been set. Similar to Embodiment 1, in accordance with the synchronization signal S0, the cell selection control circuit 115 generates the count-up signal, counts the generated count-up signal by the counter, and performs switching of the cell selection switches (the first switchover part 30 and the second switchover part 40 in FIG. 5).

The system-side microcomputer 3 transmits the measurement signal CO to all the ADCs 116 at the measurement timing T2 in FIG. 10. In accordance with the measurement signal CO, each ADC 116 converts the potential signal V0n outputted from the signal processing circuit 113 into a digital signal to generate the potential data D0n, and transmits the generated potential data D0n to the system-side microcomputer 3. The system-side microcomputer 3 receives the potential data D0n regarding each element part of each detection circuit 2, and calculates the load applied to each element part, as in Embodiment 1.

In Embodiment 4 as well, similar to Embodiment 1, charging of the element part (the first element part) of one load sensor 1 (the first load sensor) and charging of the element part (the second element part) of another load sensor 1 (the second load sensor) are synchronized with each other. Therefore, the voltage acquired by the detection circuit 2 (the first detection circuit) connected to the first load sensor can be suppressed from being influenced by noise from the detection circuit 2 (the second detection circuit) connected to the second load sensor. Therefore, the load applied to each element part of each load sensor 1 can be accurately measured.

In addition, since each detection circuit 2 can be implemented by hardware in which the microcomputer 110 is omitted, cost can be reduced.

<Modification>

In Embodiments 1 to 4, as shown in FIG. 10, for each measurement cycle for one element part, the synchronization signal S0 is generated, and the charge start timings T1 in all the detection circuits 2 are synchronized with each other. However, not limited thereto, for each predetermined number of measurement cycles, this synchronization may be performed.

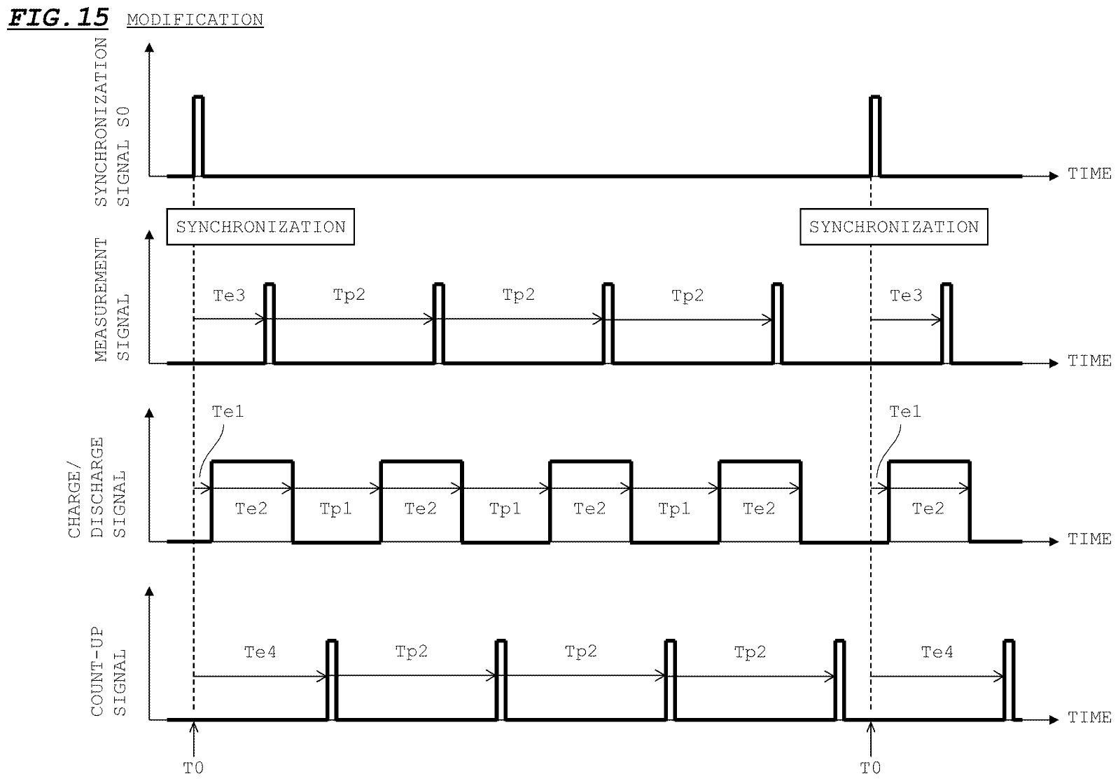

FIG. 15 is a time chart showing states of the synchronization signal S0, the measurement signal, the charge/discharge signal, and the count-up signal, according to a modification. In the example shown in FIG. 15, with one cycle defined to be composed of charging, measurement, discharging, and switching with respect to an element part, after four cycles have ended, the synchronization is performed. The synchronization timing may be at a cycle number other than four.

In a modification based on Embodiments 1 to 3, the synchronization generation part 120 outputs the synchronization signal S0 at the synchronization timing TO. When the elapsed time Te1 has elapsed from reception of the synchronization signal S0, the microcomputer 110 raises the charge/discharge signal, and when the elapsed time Te2 has elapsed from the raising of the charge/discharge signal, the microcomputer 110 lowers the charge/discharge signal. Then, when a time Tp1 has elapsed from the lowering of the charge/discharge signal, the microcomputer 110 raises the charge/discharge signal again. In this manner, raising and lowering of the charge/discharge signal are repeatedly performed.

When the elapsed time Te3 has elapsed from the reception of the synchronization signal S0, the microcomputer 110 transmits the measurement signal. Then, when a cycle time Tp2 (the time required in the process on one element part) from the transmission of the measurement signal has elapsed, the microcomputer 110 transmits the measurement signal again. In this manner, transmission of the measurement signal is repeatedly performed. When the elapsed time Te4 has elapsed from the reception of the synchronization signal S0, the microcomputer 110 transmits the count-up signal. Then, when the cycle time Tp2 has elapsed from the transmission of the count-up signal, the microcomputer 110 transmits the count-up signal again. In this manner, transmission of the count-up signal is repeatedly performed.

The synchronization generation part 120 outputs the next synchronization signal S0 at a cycle period in which four cycles assuredly end. In accordance with the next synchronization signal S0, the process corresponding to four cycles similar to the above is performed. Accordingly, even if the timing of charging/discharging in each detection circuit 2 during four cycles is slightly shifted, the charging timings in the respective detection circuits are synchronized in accordance with the next synchronization signal S0. Therefore, overlapping of the discharge period in one detection circuit 2 with the measurement timing in another detection circuit 2 is avoided, and noise due to discharging performed by the one detection circuit 2 can be suppressed from being superposed on the potential signal at the measurement timing in the other detection circuit 2.

In a modification based on Embodiment 4, the synchronization generation part 120 outputs the synchronization signal S0 at the synchronization timing TO. Based on the synchronization signal S0, the charge control circuit 114 raises the charge/discharge signal and lowers the charge/discharge signal at the timings shown in FIG. 15. Based on the synchronization signal S0, the cell selection control circuit 115 transmits the count-up signal at the timings shown in FIG. 15. The system-side microcomputer 3 transmits the measurement signal CO at the timings shown in FIG. 15. The synchronization generation part 120 outputs the next synchronization signal S0, at a cycle period in which four cycles assuredly end. Accordingly, charging timings are synchronized every four cycles.

According to the modifications described above, every time switching of the element part serving as the detection target is performed a predetermined number of times, the synchronization generation part 120 outputs the synchronization signal S0 (see FIG. 15) for synchronizing charging of the element part (the first element part) of one load sensor 1 (the first load sensor) and charging of the element part (the second element part) of another load sensor 1 (the second load sensor) with each other, to each of the one detection circuit 2 (the first detection circuit) corresponding to the first element part and the other detection circuit 2 (the second detection circuit) corresponding to the second element part. With this configuration, every time switching of the element part serving as the detection target is performed a predetermined number of times (e.g., four times), charging of the first element part and charging of the second element part are synchronized with each other. Therefore, while synchronization control is performed in a simpler manner, the voltage acquired by the other detection circuit 2 can be suppressed from being influenced by noise from the one detection circuit 2.

<Other Modifications>

The configuration of the load detection system 4 can be modified in various ways other than the configurations shown in the above embodiments and modifications.

For example, in Embodiments 1 to 4 above, as the configuration for removing noise from the potential signal outputted from the voltage measurement terminal 27, a capacitor is disposed in the signal processing circuit 113. However, as the configuration for suppressing noise that is superposed on the potential signal, another configuration may further be used. For example, a coil may be disposed in the ground line to suppress noise that propagates in the ground line. Alternatively, a power supply regulator may be disposed in each detection circuit 2 to suppress noise that propagates via the power supply line. With these configurations, noise during discharge in the one detection circuit 2 can be further suppressed from propagating to the other detection circuit 2. Therefore, should the measurement timing in the other detection circuit 2 overlap with the discharging timing in the one detection circuit 2, influence of noise on the potential signal acquired by the other detection circuit 2 can be further suppressed.

In the configuration in FIG. 5, the resistance value of the resistor 26 may be made high to gently perform discharging, whereby noise during discharge may be suppressed. However, when the resistance value of the resistor 26 becomes higher, the time required in the discharging becomes longer. Therefore, the measurement time of the voltage with respect to one element part becomes long. Therefore, it is preferable that the resistance value of the resistor 26 is set to be as high as possible in consideration of the relationship with the load measurement speed by the load sensor 1.

In Embodiments 1 to 3 above, the counter that is incremented according to the count-up signal is disposed in the drive circuit 112. However, this counter may be built in the microcomputer 110. In this case, the microcomputer 110 increments the counter according to the count-up signal generated by the microcomputer 110 itself, and outputs, to the drive circuit 112, a control signal for switching the element part having a cell number corresponding to the count value of the counter, so as to be the measurement target. The drive circuit 112 drives the cell selection switches such that the element part corresponding to the received control signal serves as the measurement target.

In Embodiment 1 above, in order to transmit the potential data D0n, all the microcomputers 110 are connected to the system-side microcomputer 3. However, only a predetermined number of the microcomputers 110 may be connected to the system-side microcomputer 3. In this case, as shown in Embodiment 3, when a microcomputer 110 that is not connected to the system-side microcomputer 3 has received the transfer request signal Rn from an adjacent microcomputer 110, the microcomputer 110 transmits the potential data D0n to the adjacent microcomputer 110. In Embodiment 3 above, in order to transmit the potential data D0n, only the microcomputer 110 that has the synchronization generation part 120 is connected to the system-side microcomputer 3. However, not limited thereto, only another microcomputer 110 may be connected to the system-side microcomputer 3, or a plurality of the microcomputers 110 may be connected to the system-side microcomputer 3.

In Embodiments 2, 4 above, the synchronization generation part 120 is provided in the system-side microcomputer 3. However, not limited thereto, the synchronization generation part 120 of this case may be disposed in a higher-order circuit, other than the system-side microcomputer 3, that is connected to the plurality of the detection circuits 2.

In the above embodiments, the electrically-conductive members 13a of the conductor wires 13 are each selectively connected to either one of the first supply line L1 and the second supply line L2 by the first switchover part 30 (six multiplexers 31). However, the first switchover part 30 need not necessarily be implemented by multiplexers, and may be implemented by a switching circuit other than the multiplexers. Similarly, the cables 12a in the electrically-conductive elastic bodies 12 are each selectively connected to either one of the second supply line L2 and the ground line L3 by the second switchover part 40 (six multiplexers 41). However, the second switchover part 40 need not necessarily be implemented by multiplexers, and may be implemented by a switching circuit other than the multiplexers.

In the above embodiments, as shown in FIG. 5, six conductor wires 13 are disposed on the upper faces of the electrically-conductive elastic bodies 12. However, the number of the conductor wires 13 is not limited to six, and may be one or more. Six electrically-conductive elastic bodies 12 are formed on the surface of the sheet-shaped member 11, but the number of the electrically-conductive elastic bodies 12 is not limited to six, and may be one or more.

In the above embodiments, the numbers of the element parts disposed in the respective load sensors 1 in the load detection system 4 are all identical to each other, but may be different from each other. When the numbers of the element parts are different, for example, at the timing when the process on all the element parts in all the load sensors 1 end, the synchronization signal S0 is transmitted. However, when the numbers of the element parts disposed in the respective load sensors 1 are identical to each other, the process on each load sensor can be performed in a similar manner, and thus, the process can be simplified.

In the above embodiments, the layouts of the element parts disposed in the respective load sensors 1 in the load detection system 4 are all identical to each other, but may be different from each other. For example, in one load sensor 1, the element parts may be disposed in 16 rows and eight columns, and in another load sensor 1, the element parts may be disposed in four rows and 32 columns. In this case as well, when the numbers of the element parts are identical to each other, the process can be simplified as described above.

In the above embodiments, the conductor wire 13 is implemented by a covered copper wire. However, not limited thereto, the conductor wire 13 may be composed of: an electrically-conductive member having a linear shape formed from a substance other than copper; and a dielectric body covering the electrically-conductive member. The electrically-conductive member in this case is implemented by, for example, a metal body, a glass body and an electrically-conductive layer formed on the surface thereof, a resin body and an electrically-conductive layer formed on the surface thereof, or the like.

In the above embodiments, the electrically-conductive elastic bodies 12 are provided only on the face on the Z-axis positive side of the sheet-shaped member 11. However, electrically-conductive elastic bodies may be provided also on the face on the Z-axis negative side of the sheet-shaped member 15. In this case, the electrically-conductive elastic bodies on the sheet-shaped member 15 side are configured similarly to the electrically-conductive elastic bodies 12 on the sheet-shaped member 11 side, and are disposed so as to be superposed on the electrically-conductive elastic bodies 12 so as to sandwich the conductor wires 13, in a plan view. Then, the cables drawn from the electrically-conductive elastic bodies on the sheet-shaped member 15 side are connected to the cables 12a drawn from the electrically-conductive elastic bodies 12 opposing in the Z-axis direction. When the electrically-conductive elastic bodies are provided above and below the conductor wires 13 in this manner, change in the capacitance in each element part becomes substantially twice correspondingly to the upper and lower electrically-conductive elastic bodies. Thus, the detection sensitivity of the load applied to the element part can be enhanced.

In the above embodiments, the dielectric body 13b is formed on the electrically-conductive member 13a so as to cover the outer periphery of the electrically-conductive member 13a. However, instead of this, the dielectric body 13b may be formed on the face on the Z-axis positive side of each electrically-conductive elastic body 12. In this case, in accordance with application of a load, the electrically-conductive member 13a sinks in and is wrapped by the dielectric body 13b and the electrically-conductive elastic body 12, and the contact area between the electrically-conductive member 13a and the electrically-conductive elastic body 12 changes. Accordingly, similar to the above embodiments, the load applied to each element part can be detected.

In addition to the above, various modifications can be made as appropriate to the embodiments of the present invention without departing from the scope of the technical idea defined by the claims.

What is claimed is:

1. A load detection system comprising:
a first load sensor including a first element part in which capacitance changes in accordance with a load;
a first detection circuit configured to perform charging and discharging of the first element part and acquire a voltage according to the capacitance at a detection timing in a charge period;
a second load sensor including a second element part in which capacitance changes in accordance with a load;
a second detection circuit configured to perform charging and discharging of the second element part and acquire a voltage according to the capacitance at a detection timing in a charge period; and
a synchronization generation part configured to synchronize the charging of the first element part and the charging of the second element part.

2. The load detection system according to claim 1, wherein
the first load sensor includes a plurality of the first element parts,
after a discharge period for the first element part serving as a detection target, the first detection circuit sequentially switches the detection target to a next one of the first element parts, to acquire the voltage,
the second load sensor includes a plurality of the second element parts, and
after a discharge period for the second element part serving as a detection target, the second detection circuit sequentially switches the detection target to a next one of the second element parts, to acquire the voltage.

3. The load detection system according to claim 2, wherein
every time an element part serving as a detection target is switched, the synchronization generation part outputs, to each of the first detection circuit and the second detection circuit, a synchronization signal for synchronizing the charging of the first element part and the charging of the second element part with each other.

4. The load detection system according to claim 2, wherein
every time switching of an element part serving as a detection target is performed a predetermined number of times, the synchronization generation part outputs, to each of the first detection circuit and the second detection circuit, a synchronization signal for synchronizing the charging of the first element part and the charging of the second element part with each other.

5. The load detection system according to claim 1, wherein
the synchronization generation part is disposed in the first detection circuit.

6. The load detection system according to claim 1, wherein
the synchronization generation part is disposed in a higher-order circuit connected to the first detection circuit and the second detection circuit.

7. The load detection system according to claim 1, wherein
the number of the first element parts disposed in the first load sensor and the number of the second element parts disposed in the second load sensor are identical to each other.
